(19) United States
(12) Patent Application Publication
(10) Pub. No.: US 2007/0248918 A1
(43) Pub. Date: Oct. 25, 2007

(54) Compositions, systems and methods for imaging

(76) Inventors: Vladek Kasperchik, Corvallis, OR (US); Makarand P. Gore, Corvallis, OR (US); Cari L. Dorsh, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/410,719

(22) Filed: Apr. 25, 2006

(51) Int. Cl. G03C 1/00

(52) U.S. Cl. 430/332

(57) ABSTRACT

Briefly described, embodiments of this disclosure include light directed imaging layers, light directed image recording media, and methods of preparation of each. One exemplary embodiment of the light directed imaging layer, among others, includes a matrix; a developer substantially dissolved in the matrix; a color former that is substantially insoluble in the matrix at ambient conditions and is substantially uniformly distributed in the matrix; and a pigment antenna uniformly distributed in the matrix, wherein the pigment antenna has the characteristic of absorbing an imaging radiation, and wherein the pigment antenna has a diameter less than the wavelength of the imaging radiation.

### BACKGROUND

Materials that produce color change upon stimulation with energy such as light or heat may have possible applications in imaging. For example, such materials may be found in thermal printing papers and instant imaging films. Generally, the materials and compositions known so far may require a multifilm structure and further processing to produce an image (e.g., instant imaging films such as Polaroid). And in the case of facsimile and thermal head media, high energy input of greater than 1 J/cm² is needed to achieve good images. The compositions in multifilm media may require control of diffusion of color-forming chemistry and further processing, and are in separate phases and layers. Most thermal and facsimile paper coatings consist of coatings prepared by preparing fine dispersions of more than two components. The components mix and react upon application of energy, resulting in a colored material. To the necessary mixing, the particles need to contact across three or more phases or layers (e.g., in a thermochromic system the reactive components are separated by the barrier phase) and merge into a new phase. Because of these multiple phases and layers, high energy is required to perform this process. For example, a relatively powerful carbon dioxide laser with an energy density of 3 J/cm² at times of much greater than 100 μs may be needed to produce a mark. In some instances, this high energy application may cause damage to the imaging substrate. In many situations, it may be desirable to produce a visible mark more efficiently using either a less intense, less powerful, and/or shorter energy application. Therefore, there is a need for fast marking coatings, possibly composed of fewer than three phases and in single layer.

### SUMMARY

Briefly described, embodiments of this disclosure include light directed imaging layers, light directed image recording media, and methods of preparation of each. One exemplary embodiment of the light directed imaging layer, among others, includes a matrix; a developer substantially dissolved in the matrix; a color former that is substantially insoluble in the matrix at ambient conditions and is substantially uniformly distributed in the matrix; and a pigment antenna uniformly distributed in the matrix, wherein the pigment antenna has the characteristic of absorbing an imaging radiation, and wherein the pigment antenna has a diameter less than the wavelength of the imaging radiation.

One exemplary embodiment of the light directed image recording media, among others, includes a substrate having a two-phase layer disposed thereon. The two-phase layer includes: a matrix; a developer substantially dissolved in the matrix; a color former that is substantially insoluble in the matrix at ambient conditions and is substantially uniformly distributed in the matrix; and an pigment antenna uniformly distributed in the matrix, wherein the pigment antenna has the characteristic of absorbing an imaging radiation, and wherein the pigment antenna has a diameter less than the wavelength of the imaging radiation.

One exemplary embodiment of the method for preparing an light directed imaging material, among others, includes: providing a matrix, a color former, and a developer; dissolving the developer substantially in the matrix; and distributing each of the color former and a pigment antenna substantially uniformly in the matrix, wherein the color former is substantially insoluble in the matrix at ambient conditions, wherein the pigment antenna has the characteristic of absorbing an imaging radiation, and wherein the pigment antenna has a diameter less than the wavelength of the imaging radiation.

### BRIEF DESCRIPTION OF THE DRAWINGS

Many aspects of this disclosure can be better understood with reference to the following drawings. The components in the drawings are not necessarily to scale. Moreover, in the drawings, like reference numerals designate corresponding parts throughout the several views.

FIG. 1 illustrates an illustrative embodiment of the light directed imaging medium.

FIG. 2 illustrates a representative embodiment of a printer system.

FIG. 3 illustrates a representative process for making an embodiment of a two-phase layer.

### DETAILED DESCRIPTION

Embodiments of the disclosure include imaging layers (e.g., two-phase layers), methods of making the two-phase layers, and methods of using the two-phase layers. The two-phase layer includes, but is not limited to, a matrix, a developer, a color former, and a pigment antenna. The developer is dissolved or substantially dissolved in the matrix. The color former and the pigment antenna are insoluble or substantially insoluble in the matrix at ambient conditions. The color former and the pigment antenna are uniformly or substantially uniformly distributed in the matrix. It should be noted that imaging layer is also referred to as a “light directed imaging layer” and a “two-phase layer.”

The pigment antenna has the characteristic of absorbing an imaging radiation. In addition, the pigment antenna has a diameter comparable to or less than the wavelength of the imaging radiation. The sub-micron size of the pigment antenna improves the absorbing efficiency of the pigment antennas because light scattering and/or reflection are reduced. The use of the pigment antenna in the two-phase layer improves robustness of marking sensitivity and long term stability in ambient light relative to other imaging layers. This is advantageous because dye-based antenna degrade quickly when exposed to ambient light.

The two-phase layer can be a coating disposed onto a substrate and used in structures such as, but not limited to, paper media, digital recording media, and the like. A clear mark and excellent image quality can be obtained by directing radiation energy (e.g., a 780 nm laser operating at 45 MW) at areas of the two-phase layer. In an illustrative example the components used to produce the mark via a color change upon stimulation by energy can include a color former (e.g., a leuco dye) dispersed in the matrix as a separate phase and the developer dissolved in a matrix (e.g., a radiation-cured acrylate polymer).

In particular embodiments, the color former and the pigment antenna are substantially insoluble in the matrix at ambient conditions, while the developers are substantially soluble in the matrix. The pigment antenna functions to absorb energy, convert the energy into heat, and deliver the heat to the reactants. The energy may then be applied by the way of an infrared laser. Upon application of the energy, both the developers and the color-former may become heated (e.g., solubilizing the color former) and mix, which causes the color-former to become activated and cause a mark (color) to be produced.

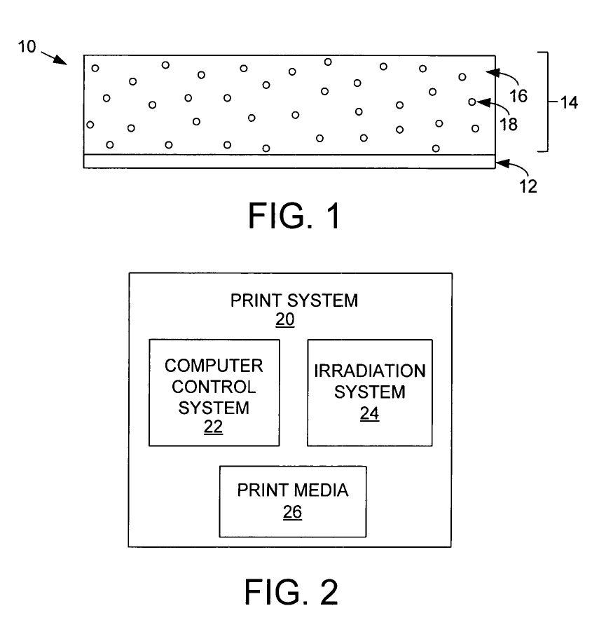

FIG. 1 illustrates an embodiment of an imaging medium 10. The imaging medium 10 can include, but is not limited to, a substrate 12 and a two-phase layer 14. The substrate 12 may be a substrate upon which it is desirable to make a mark, such as, but not limited to, packaging materials (e.g., paper and plastic packaging materials for perishable and non-perishable items), paper media (e.g., labels, tickets, receipts, or stationary), overhead transparencies, a metal/metal composite, glass, a ceramic, a polymer, digital audio media (e.g., a compact disk (CD) (e.g., CD-R/RW/ROM)), and digital video media (DVD) (e.g., DVD-R/RW/ROM).

The two-phase layer 14 can include, but is not limited to, a matrix 16, an developer, a color former, and a pigment antenna. The developer and the color former, when mixed upon heating (e.g., both are substantially dissolved in the matrix 16), may change color to form a mark. The developer is substantially soluble in the matrix 16. The color former is substantially insoluble in the matrix 16 and may be suspended in the matrix 16 as substantially uniformly distributed insoluble particles 18. The pigment antenna is substantially uniformly distributed in the matrix 16. The pigment antenna may be suspended in the matrix 16 separate from (not shown) or as an alloy with the color former (e.g., insoluble particles 18). In the latter situation, the pigment antenna may be uniformly dispersed in the color-former phase.

The two-phase layer 14 may be applied to the substrate 12 via any acceptable method, such as, but not limited to, rolling, spraying, and screen-printing. In addition, one or more layers can be formed between the two-phase layer 14 and the substrate 12 and/or one or more layers can be formed on top of the two-phase layer 14. In one embodiment, the two-phase layer 14 is part of a CD or a DVD.

To form a mark, radiation energy is directed imagewise at one or more discrete areas of the two-phase layer 14 of the imaging medium 10. The form of radiation energy may vary depending upon the equipment available, ambient conditions, the desired result, and the like. The radiation energy can include, but is not limited to, infrared (IR) radiation, ultraviolet (UV) radiation, x-rays, and visible light.

The pigment antenna absorbs the radiation energy and heats the area of the two-phase layer 14 to which the radiation energy impacts. The heat may cause suspended insoluble particles (color-former phase) 18 to reach a temperature sufficient to cause the melting and subsequent rapid dissolution/diffusion into the matrix phase of the color former initially present in the insoluble particles 18 (e.g., glass transition temperatures (T_{g}) or melting temperatures (Tₘ) of insoluble particles 18 and matrix). Apart from melting the matrix 16, heat also reduces the matrixes 16 melt viscosity, and accelerates the diffusion rate of the color-forming components (e.g., leuco-dye and developers), thus speeding up the color formation rate. The developer and color former may then react to form a mark (color) on certain areas of the two-phase layer 14.

FIG. 2 illustrates a representative embodiment of a print system 20. The print system 20 can include, but is not limited to, a computer control system 22, an irradiation system 24, and print media 26 (e.g., imaging media). The computer control system 22 is operative to control the irradiation system 24 to cause marks (e.g., printing of characters, symbols, photos, and the like) to be formed on the print media 26. The irradiation system 24 can include, but is not limited to, a laser system, UV energy system, IR energy system, visible energy system, x-ray system, and other systems that can produce radiation energy to cause a mark to be formed on the two-phase layer 14. The print system 20 can include, but is not limited to, a laser printer system and an ink-jet printer system. In addition, the print system 20 can be incorporated into a digital media system. For example, the print system 20 can be operated in a digital media system to print labels (e.g., the two-phase layer is incorporated into a label) onto digital media such as CDs and DVDs. Furthermore, the print system 20 can be operated in a digital media system to directly print onto the digital media (e.g., the two-phase layer is incorporated in the structure of the digital media).

The matrix 16 can include compounds capable of and suitable for dissolving and/or dispersing the developer at ambient conditions. The matrix 16 can include, but is not limited to, UV curable monomers, oligomers, and pre-polymers (e.g., acrylate derivatives). Illustrative examples of UV-curable monomers, oligomers, and pre-polymers (that may be mixed to form a suitable UV-curable matrix) can include, but are not limited to, hexamethylene diacrylate, isobornyl acrylate, tripropylene glycol diacrylate, lauryl acrylate, isodecyl acrylate, neopentyl glycol diacrylate, 2-phenoxyethyl acrylate, 2(2-ethoxy)ethylacrylate, polyethylene glycol diacrylate and other acrylated polyols, trimethylolpropane triacrylate, pentaerythritol tetraacrylate, ethoxylated bisphenol A diacrylate, acrylic oligomers with epoxy functionality, and the like.

In an embodiment the matrix 16 is used in combination with a photo package. A photo package may include, but is not limited to, a light absorbing species, which initiates reactions for curing of a matrix such as, by way of example, benzophenone derivatives. Other examples of photoinitiators for free radical polymerization monomers and pre-polymers include, but are not limited to, thioxanethone derivatives, anthraquinone derivatives, acetophenones and benzoine ether types, and the like.

It may be desirable to choose a matrix 16 that is cured by a form of radiation other than the type of radiation that causes a color change. The matrix 16 based on cationic polymerization resins may include photo-initiators based on aromatic diazonium salts, aromatic halonium salts, aromatic sulfonium salts and metallocene compounds, for example. An example of the matrix 16 may include Nor-Cote CDG000. Other acceptable matrices 16 may include, but is not limited to, a mixture of acrylated polyester oligomers (e.g., CN293 and CN294, available from Sartomer Co.).

The matrix 16 is from about 2 wt % to 98 wt % of the two-phase layer and most preferably from about 20 wt % to 90 wt % of the two-phase layer.

The term “pigment antenna” includes a radiation absorbing compound in which the pigment antenna readily absorbs a desired specific wavelength of the marking radiation. The pigment antenna may be a material that effectively absorbs the type of energy to be applied to the imaging medium 10 to effect a mark or color change.

In an embodiment, a pigment antenna has a diameter less than the wavelength of the imaging radiation, a pigment antenna has a diameter less than three quarters the wavelength of the imaging radiation, a pigment antenna has a diameter less than half the wavelength of the imaging radiation, and a pigment antenna has a diameter less than a quarter the wavelength of the imaging radiation. In an embodiment, the light scattering and/or reflection of the pigment antenna decreases as the diameter of the pigment antenna decreases. It should be noted that the pigment antenna is substantially spherical. However, the pigment antenna may have a non-spherical shape (e.g., oval shape) and the diameter is measured from the largest cross-section of the pigment antenna.

In an embodiment, the pigment antenna has a diameter from about 200 to 400 nanometers (nm), about 250 to 350 nm, and about 300 nm.

The pigment antenna can include, but is not limited to, 980 nm pigment antennas, 780 nm pigment antennas, 650 nm pigment antennas, combinations thereof, and the like. The 780 nm pigment antennas can include, but are not limited to, phthalocyanine submicron pigments (e.g., YKR-5010 (Product of “Yamamoto Chemicals, Inc.”, average particle size of 300 nm or less); silicon 2,3-naphthalocyanine bis(trihexylsiloxide) (CAS No. 92396-88-8) (Lambda max - 775 nm) milled down to prticle size 300 nm or less); NIR pigments (e.g., insoluble cyanine NIR dyes with extintion maximum in the vicinity of about 780 nm), and combinations thereof. The 650 nm pigment antennas can include, but are not limited to, matrix insoluble copper phthalocyanine, copper phthalocyanine derivatives, and combinations thereof.

The pigment antenna is about 0.01 wt % to 10 wt % of the two-phase layer, preferably about 0.1 wt % to 7 wt % of the two-phase layer, and most preferably about 0.4 wt % to 5 wt % of the two-phase layer.

As used herein, the term “developer” is a substance that reacts with a color former and causes the color former to alter its chemical structure and change or acquire color. The developer can include, but is not limited to, a phenolic developer species capable of developing color when reacting with leuco dye and soluble or partially soluble in the matrix. The developer can include, but is not limited to, phenolic compounds such as, for example: bis-phenol A, p-hydroxy benzyl benzoate, bisphenol S (4,4-dihydroxydiphenyl sulfone), 2,4-dihydroxydiphenyl sulfone, bis(4-hydroxy-3-allylphenyl) sulfone (Trade name -TG-SA), 4-hydroxyphenyl-4′-isopropoxyphenyl sulfone (Trade name - D8), 4-hydroxyphenyl sulfone, 2,4′-dihydroxydiphenyl sulfone, bis(4-hydroxy-3-allylphenyl) sulfone, 2,2′,5,5′-tetrahydroxy diphenyl sulfone, 4-hydroxyphenyl-4′-isopropoxyphenly sulfone, 2,2-bis(4-hydroxyphenyl)propane, and combinations thereof. In addition, the developer can include, but is not limited to, sulfonylamide and sulfonylurea developers (e.g., benzenesulfonamide and N-p-Tolylsulfonyl-N′-3-(p-tolylsulfonyloxy)phenylurea (manufactured by “Ciba” as “Pergafast-201 ”)).

In particular, the developer is from about 0.1 wt % to 25 wt %, about 0.2 wt % to 20 wt % of the two-phase layer, and about 1 wt % to 20 wt % of the two-phase layer.

The term “color former” is a color forming substance, which is colorless or one color in a non-activated state and produces or changes color in an activated state. The color former can include, but is not limited to, leuco dyes and phthalide color formers (e.g., fluoran leuco dyes and phthalide color formers as described in “The Chemistry and Applications of Leuco Dyes”, Muthyala, Ramiah, ed., Plenum Press (1997) (ISBN 0-306-45459-9), incorporated herein by reference). Examples of fluoran leuco dyes include the structure shown in Formula (1) 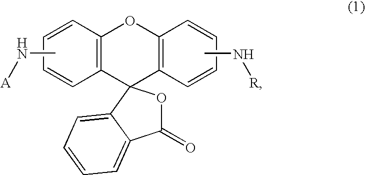
where A and R are aryl or alkyl groups.

The leuco dyes can include, but are not limited to, fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(p-hydroxyphenyl) 4,5-diphenylimidazoles, indanones, leuco indamines, hydrozines, leuco indigoid dyes, amino-2,3-dihydroanthraquinones, tetrahalo-p,p′-biphenols, 2(p-hydroxyphenyl)-4,5-diphenylimidazoles, phenethylanilines, and mixtures thereof.

In one aspect of the present disclosure, the leuco dye can be a fluoran, phthalide, aminotriarylmethane, or mixture thereof. Several non-limiting examples of suitable fluoran based leuco dyes include 3-diethylamino-6-methyl-7-anilinofluorane, 3-(N ethylp-toluidino)-6-methyl-7-anilinofluorane, 3-(N-ethyl-N-isoamylamino)-6 methyl-7-anilinofluorane, 3-d iethylamino-6-methyl-7-(o, p-dimethylanilino)fluorane, 3 pyrrolid ino-6-methyl-7-an ilinofluorane, 3-piperidino-6-methyl-7-anilinofluorane, 3-(N-cyclohexyl-N-methylamino)-6-methyl-7-anilinofluorane, 3-diethylamino-7-(m-trifluoromethylanilino)fluorane, 3-dibutylamino-6-methyl-7-anilinofluorane, 3-diethylamino-6-chloro-7-anilinofluorane, 3-dibutylamino-7-(o-chloroanilino) fluorane, 3-diethylamino-7-(o-chloroanilino)fluorane, 3-di-n-pentylamino-6-methyl-7-anilinofluoran, 3-di-n-butylamino-6-methyl-7-anilinofluoran, 3-(n-ethyl-n isopentylamino)-6-methyl-7-anilinofluoran, 3-pyrrolid ino-6-methyl-7-anilinofluoran, 1(3H)-isobenzofuranone,4,5,6,7-tetrachloro-3,3-bis[2-[4-(dimethylamino)phenyl]-2-(4-methoxyphenyl)ethenyl], and mixtures thereof.

Aminotriarylmethane leuco dyes can also be used in the present disclosure such as, but not limitied to, tris (N,N-dimethylaminophenyl) methane (LCV); deutero-tris(N,N dimethylaminophenyl)methane (DLCV); tris(N,N-diethylaminophenyl) methane(LECV); deutero-tris(4-diethylaminolphenyl) methane (D-LECV); tris(N,N-di-n-propylaminophenyl) methane (LPCV); tris(N,N-dibutylaminophenyl) methane (LBCV); bis(4-diethylaminophenyl)-(4-diethylamino-2-methyl-phenyl) methane (LV-1); bis(4-diethylamino-2-methylphenyl)-(4-diethylamino-phenyl) methane (LV-2); tris(4-diethylamino-2-methylphenyl) methane (LV-3); deutero-bis(4-diethylaminophenyl)-(4-diethylamino-2-methylphenyl) methane (D-LV-1); deutero-bis(4-diethylamino-2-methylphenyl)(4-diethylaminophenyl) methane (D-LV-2); bis(4-d iethylam ino-2-methylphenyl)(3,4-dimethoxyphenyl) methane (LB-8); aminotriarylmethane leuco dyes having different alkyl substituents bonded to the amino moieties wherein each alkyl group is independently selected from C1-C4 alkyl; and aminotriaryl methane leuco dyes with any of the preceding named structures that are further substituted with one or more alkyl groups on the aryl rings wherein the latter alkyl groups are independently selected from C1-C3 alkyl. Other leuco dyes can also be used in connection with the present disclosure and are known to those skilled in the art. A more detailed discussion of some of these types of leuco dyes may be found in U.S. Pat. Nos. 3,658,543 and 6,251,571, each of which are hereby incorporated by reference in their entireties. Examples are found in “Chemistry and Applications of Leuco Dyes”, Muthyala, Ramaiha, ed.; Plenum Press, New York, London; ISBN: 0-306-45459-9, incorporated herein by reference.

The color former is from about 1 wt % to 80 wt % of the two-phase layer and from about 5 wt % to 50 wt % of the two-phase layer.

The developer and the color former react with one another to produce a mark. The developers and color former may be three or more substances that when reacted together produce color change. When reacted, the developers may initiate a color change in the color former or develop the color former.

In an embodiment, the color former also includes an alloy (amorphous eutectic or polycrystalline) including a leuco-dye and a melting accelerator, for example. The presence of the melting accelerator assists in reducing the melting temperature of high-melting fluoran dyes and, thus, provides improved reactivity upon heating. Use of the melting accelerator also facilitates uniform dissolution of the antenna in the leuco-dye alloy.

In an embodiment, the leuco-dye alloy (eutectic) can be prepared by dissolving the pigment antenna in a melting accelerator melt. The leuco-dye is then dissolved in the accelerator melt, which results in the formation of a leuco-dye/accelerator/pigment antenna alloy. The alloy is then cooled down and ground to a fine powder, preferably having a particle size of not larger than about 20 μm, and more preferably of less than 10 μm.

The melting accelerator can include, but is not limited to, crystalline organic solids with melting temperatures in the range of about 50° C. to about 150° C., and preferably having melting temperature in the range of about 70° C. to about 120° C. The melting accelerator can include, but is not limited to, aromatic hydrocarbons (or their derivatives) that provide good solvent characteristics for leuco-dye used in the formulations and methods of the present disclosure. In addition to dissolving leuco-dye, the melting accelerator may also assist in reducing the melting temperature of the leuco-dye and stabilize the leuco-dye alloy in the amorphous state (or slow down the recrystallization of the leuco-dye alloy into individual components). The melting accelerator for use in the current disclosure include, but are not limited to, m-terphenyl, p-benzyl biphenyl, Â-naphtol benzylether, 1,2-bis (3,4]dimethylphenyl) ethane, and combinations thereof.

By “substantially insoluble,” it is meant that the solubility of the color former in the matrix at ambient conditions is so low, that no or very little color change may occur due to reaction of the color former and the developers at ambient conditions.

By “substantially soluble,” it is meant that the solubility of the developer in the matrix at ambient conditions is high, that all or most of the developer present in the two-phase layer is dissolved in the matrix.

Although, in the embodiments described above, the developers may be dissolved in the matrix and the color former remains suspended as a substantially insoluble particle in the matrix at ambient conditions, it is also acceptable that the color former may be dissolved in the matrix and the developers may remain as a substantially insoluble particle at ambient conditions.

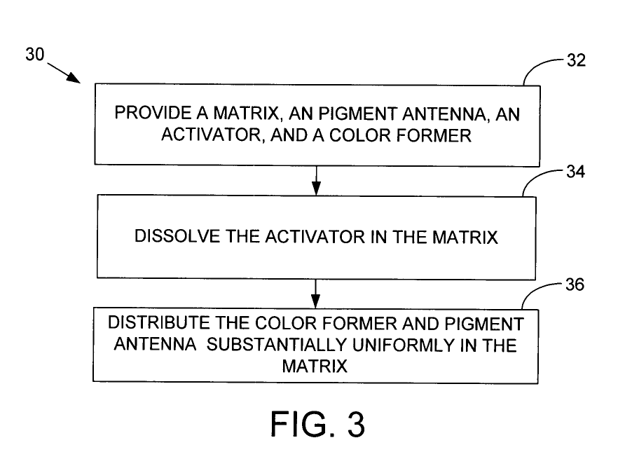

FIG. 3 illustrates a representative process 30 for making the two-phase layer 14. In block 32, the matrix, the pigment antenna, the developer, and the color former, are provided. In block 34, the developer is dissolved in the matrix. The color former is substantially insoluble in the matrix at ambient conditions. In block 36, the color former and the pigment antenna are distributed substantially uniformly in the matrix. Subsequently, the two-phase layer 14 can be disposed on a substrate 12 to form the imaging medium 10.

### EXAMPLE 1

Table 1 illustrates an exemplar embodiment of the present disclosure.

TABLE 1
2-Phase Laser-imageable formulation with NIR pigment

| YKR-186 in J278 type ink | wt. % |
|---|---|
| UV-curable monomers mix | 58.00% |
| D-8 | 8.45% |
| Proprietary NIR Pigment | 1.42% |
| Sulfonyl diphenol | 3.75% |
| Yoshinox SR | 2.18% |
| Irgacure-1300 Photoinitiator | 6.20% |
| BK400 Leuco Dye milled | 20.00% |
| Total | 100.00% |
| UV-curable monomers mix | Wt % |
| SR238 (1,6-hexanediol diacrylate) | 36.52% |
| Ebecryl 605 | 26.00% |
| SR395 (isodecyl acrylate) | 19.00% |
| SR306 HP(tripropylene glycol diacrylate) | 18.48% |
| | 100.00% |

Yoshinox SR—is a trade name for Bis(2-methyl-4-hydroxy-5-tert-butylphenyl) sulfide;

D8—is a trade name for 4-hydroxy-4′-isopropoxydiphenyl sulfone.

The resulting formulation is UV-curable screen-printable ink. It can be screen printed onto a CD or a DVD surface at coating thickness 6-8 μm. After printing and UV-curing of the coating it can be imaged with 780 nm NIR laser. At laser power about 45 mW a reasonable to high contrast marks 20 μm×45 μm can be produced within 40 to 100 μS duration.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

1. A light directed imaging layer comprising:
a matrix;
a developer substantially dissolved in the matrix;
a color former that is substantially insoluble in the matrix at ambient conditions and is substantially uniformly distributed in the matrix; and
a pigment antenna uniformly distributed in the matrix, wherein the pigment antenna has the characteristic of absorbing an imaging radiation, wherein the imaging radiation is selected from 980, 760, and 650 nanometers, wherein the pigment antenna has a diameter less than the wavelength of the imaging radiation, and wherein the pigment antenna has a diameter of about 200 to 400 nanometers.

2. The light directed imaging layer of claim 1, wherein the pigment antenna has a diameter less than half the wavelength of the imaging radiation.

3. The light directed imaging layer of claim 1, wherein the pigment antenna has a diameter less than a quarter the wavelength of the imaging radiation.

4. (canceled)

5. The light directed imaging layer of claim 1, wherein the pigment antenna has a diameter of about 250 to 350 nanometers.

6. The light directed imaging layer of claim 1, wherein the developer comprises a phenolic developer.

7. The light directed imaging layer of claim 1, wherein the matrix is selected from an ultraviolet curable monomers, ultraviolet oligomers, pre-polymers of ultraviolet polymers, and combinations thereof.

8. The light directed imaging layer of claim 1, wherein the color former comprises at least one compound selected from a leuco dye and a leuco dye alloy.

9. The light directed imaging layer of claim 1, wherein the pigment antenna is selected from one of the following: a pigment antenna that absorbs at 980 nm wavelength, a pigment antenna that absorbs at 780 nm wavelength, a pigment antenna that absorbs at 650 nm wavelength, and combinations thereof.

10. The light directed imaging layer of claim 1, wherein the pigment antenna is substantially spherical.

11. The light directed imaging layer of claim 1, wherein the pigment antenna is non-spherical.

12. An image recording medium comprising:
a substrate having a two-phase layer disposed thereon, wherein the two-phase layer includes:
a matrix;
an developer substantially dissolved in the matrix;
a color former that is substantially insoluble in the matrix at ambient conditions and is substantially uniformly distributed in the matrix; and
a pigment antenna uniformly distributed in the matrix, wherein the pigment antenna has the characteristic of absorbing an imaging radiation, wherein the imaging radiation is selected from 980, 760, and 650 nanometers, wherein the pigment antenna has a diameter less than the wavelength of the imaging radiation, and wherein the pigment antenna has a diameter of about 200 to 400 nanometers.

13. The image recording medium of claim 12, wherein the substrate is selected from a paper medium, a transparency, a compact disk (CD), and a digital video disk (DVD).

14. The image recording medium of claim 12, wherein the substrate is selected from a CD-R/RW/ROM and DVD-R/RW/ROM.

15. The image recording medium of claim 12, wherein the substrate is a packaging material.

16. The image recording medium of claim 12, wherein the pigment antenna has a diameter less than half the wavelength of the imaging radiation.

17. The image recording medium of claim 12, wherein the pigment antenna has a diameter less than a quarter of the wavelength of the imaging radiation.

18. (canceled)

19. The image recording medium of claim 10, wherein the matrix is about 2 wt % to 98 wt % of the layer, wherein the developer is about 0.1 wt % to 25 wt % of the layer, wherein the color former is about 1 wt % to 80 wt % of the layer, and wherein the pigment antenna is about 0.01 wt % to about 10 wt % of the layer.

20. A method for preparing an light directed imaging material, the method comprising:
providing a matrix, a color former, and an developer;
dissolving the developer substantially in the matrix; and distributing each of the color former and an pigment antenna substantially uniformly in the matrix, wherein the color former is substantially insoluble in the matrix at ambient conditions, wherein the pigment antenna has the characteristic of absorbing an imaging radiation, wherein the imaging radiation is selected from 980, 760, and 650 nanometers, wherein the pigment antenna has a diameter less than the wavelength of the imaging radiation, and wherein the pigment antenna has a diameter of about 200 to 400 nanometers.

21. The method of claim 20, further comprising:
disposing the imaging material onto a substrate, wherein the substrate is selected from a paper media, a transparency, a compact disk (CD), and a digital video disk (DVD).

22. A light directed image recording medium made by the method of claim 20.

23. The light directed imaging layer of claim 1, wherein the pigment antenna is selected from one of the following: phthalocyanine submicron pigments having an average particle size of 300 nm or less, silicon 2,3-naphthalocyanine bis(trihexylsiloxide) having a particle size 300 nm or less, and combinations thereof.

24. The light directed imaging layer of claim 1, wherein the pigment antenna is selected from one of the following: insoluble copper phthalocyanine, copper phthalocyanine derivatives, and combinations thereof.

25. The light directed imaging layer of claim 1, wherein the pigment antenna is a silicon 2,3-naphthalocyanine bis(trihexylsiloxide) having a particle size 300 nm or less.
